(19) United States
(12) Patent Application Publication
(10) Pub. No.: US 2009/0028463 A1
(43) Pub. Date: Jan. 29, 2009

(54) Unique digital imaging method

(76) Inventors: Matthew C. Putman, Brooklyn, NY (US); John B. Putman, Cuyahoga Falls, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/880,516

(22) Filed: Jul. 23, 2007

(51) Int. Cl. G06K 9/32

(52) U.S. Cl. 382/293

(57) ABSTRACT

A method for using an image sensor to obtain an image of a specimen focused thereon, such that the resolution of the image obtained is greater than the designed resolution of the image sensor includes focusing the specimen onto an image sensor having multiple pixels. Relative movement is carried out between the specimen and the image sensor to place the specimen at a plurality of discrete positions relative to the image sensor, and establishes sub-pixels and a plurality of equivalent sub-pixels, wherein equivalent sub-pixels are those sub-pixels that have the same portion of the specimen focused thereon at different discrete positions. Images of the specimen are digitally captured by means of the image sensor at each of the plurality of discrete positions, wherein a pixel value is recorded for each of the multiple pixels of the image sensor. A sub-pixel value is then determined for each sub-pixel of the image sensor by comparing the pixel values attributed to equivalent sub-pixels, and a sub-pixelated image of the specimen is reproduced based on the sub-pixel values determined

### TECHNICAL FIELD

The present invention generally resides in the art of digital imaging, and, more particularly to a method for increasing the resolution that can be achieved with a digital image sensor. Relative movement between a specimen and a digital image sensor is employed to permit the calculation and reproduction of an image having a resolution greater than the resolution of the image sensor. With movement in the nanoscale, this technique can be used to process an object that is smaller than the ultimate diffraction limit of the light employed for recording an image of the specimen.

### BACKGROUND OF THE INVENTION

Optical Microscopy has been a preferred method for measurement of structures because of its ease of use and relative cost effectiveness. Traditionally, however, optical microscopes possessed two drawbacks; the subjective nature of analysis, and the limits in resolution power due to the wavelengths of visible light.

Generally, sophisticated tools such as scanning probe microscopes, and laser interferometers, have been utilized for high resolution optical microscopy. While accurate in the nanoscale, they are complex instruments, which require long sample preparation and testing time. When attempting to image objects that are slightly larger than the diffraction limit of visible light, laser interferometers are often used.

Scanning probe microscopy (SPM) is a general term which describes two types of high resolution microscopes, the Scanning Tunneling Microscope (STM) and the Atomic Force Microscope (AFM). Both instruments use a tip of several nanometers in width to measure surface forces. The STM does not actually come into contact with the surface, but instead measures the electron tunneling current between the tip and a conductive surface. The AFM does come into contact with the surface and measures micro-adhesion caused by molecular bonds, such as van der Waals. In addition to force measurement, topography of the surface in the nanometer range can be generated using both of these techniques. In order to measure a surface as small as 1 mm², however, the time required becomes too long to be practical. Piezo electric translation stages, or other nanotranslation stages that are capable of moving a smaller distance than traditional mechanical devices, position a sample. By employing a laser and placing the SPM tip on a cantilever, topography may be assessed in nanoscale dimensions.

Laser interferometry has been used for research of light behavior, and surface phenomena. The use of coherent (laser) light can isolate electromagnetic wavelengths and can be directed easily and accurately using mirrors. U.S. Pat. No. 6,512,385 describes a method of isolating wavelengths on a surface, and comparing results from more than one wavelength using interferometry. This comparison gives useful data, but not a direct measurement of sub-visible wavelength phenomena.

Subjectivity of more common optical methods has been reduced, and in some cases eliminated with the advent of computer imaging and processing. With the availability of digital cameras, an image of a specimen in a microscope can be captured, and pixilated. Common computer algorithms can then be used to analyze the image, providing not only a visible image for record, but also quantitative analysis including particulate counts, as well as area and spectral histograms.

However, when one combines an optical microscope with two-dimensional opto-electronic sensor(s) for data acquisition, two limits of resolution exist, as below.

1. The Abbe Limit

The angular aperture (alpha) of the objective lens must be large enough to admit both the zeroth and the first order of the diffraction maxima, originating from the interference of the incident light wave with the object. With “D” as the object size and “phi” as the angle of the first diffraction maximum,

Sin phi=lambda/D

Knowing alpha, the numerical aperture is n sin alpha, where n is the refractive index of the medium in the space between the object and the lens (usually air, with a refractive index of 1). Therefore, the condition is sin phi<sin alpha or

D>lambda/(n sin alpha)

For a microscope, alpha is usually about 80°. Generally speaking, in order to resolve an object of the size D, D must be larger than the smallest wavelength of light used. If the detector is the human eye, the shortest wavelength is about 400 nm.

Using light of even shorter wavelengths can help resolve smaller objects, but requires (a) lenses which do not block UV light and (b) sensors that are sensitive in that shorter wavelength portion of the light spectrum. Nevertheless, any kind of sensor has to fulfill the second requirement below.

2. The Spatial Resolution Limit

When using a traditional optical microscope, the eye can only detect a limited spectrum of light, and the aperture is therefore the limiting factor respecting resolution. However, when employing an opto-electronic sensor for data acquisition, the resolution may be limited beyond the Abbe limit due to the spatial resolution limits of such devices. This is where the proposed invention comes into play, working to improve the resolution achieved with digital image sensors.

In the prior art, “nanopositioning” is one method that is employed to increase micron and submicron resolution. In nanopositioning techniques, means such as a piezoelectric positioner, described above, moves the specimen or SPM tip several nanometers at a time, and the displacement of the tip is recorded at each location by a computer. Once readings have been recorded over a specified scan area, a digital representation of the scanned surface is generated and the combined digital representations are analyzed together to create a higher resolution image than any of the discrete images alone. Notably, this is employed for mechanical imaging means, such as AFM and SPM imaging, but has not been employed for diffused light optical microscopy.

Thus, this invention proposes methods for increasing the resolution that can be achieved employing digital image sensors and diffused light.

### SUMMARY OF THE INVENTION

This invention generally provides a method for using an image sensor to obtain an image of a specimen focused thereon, such that the resolution of the image obtained is greater than the designed resolution of the image sensor. The specimen to be imaged is focused onto an image sensor having multiple pixels. Relative movement is carried out between the specimen and the image sensor, moving one or the other or both in planes parallel to one another such that the relative movement is in either x or y directions or both. This relative movement places the specimen at a plurality of discrete positions relative to the image sensor, and establishes sub-pixels and a plurality of equivalent sub-pixels, wherein equivalent sub-pixels are those sub-pixels that have the same portion of the specimen focused thereon at different discrete positions. Images of the specimen are digitally captured by means of the image sensor at each of the plurality of discrete positions, wherein a pixel value is recorded for each of the multiple pixels of the image sensor, with the understanding that the pixel value recorded for a given pixel is attributed to all sub-pixels established in that pixel. A sub-pixel value is then determined for each sub-pixel of the image sensor by comparing the pixel values attributed to equivalent sub-pixels, and a sub-pixelated image of the specimen is reproduced based on the sub-pixel values determined.

It will be appreciated that a “pixel value” is the digital information recorded for a pixel that is ultimately converted by appropriate media to reproduce a visual representation of that pixel. This is a well known concept in digital imaging.

The present invention addresses the resolution limits of optical microscopy through the convergence of several key technologies. Modem digital image sensors, such as CCD and CMOS microchips, provide the base on which all measurements are to be taken. Particularly, the image sensors provide a matrix of pixels of known dimensions. Although the size of pixels may decrease as advances are made in image sensor technology, they will necessarily remain larger than the diffraction limit of visible light because anything lower would not be useful in capturing more detailed images. The second key component is a positioning element, such as a piezoelectric nanopositioning stage, which is capable of moving an item with which it is associated in distances as small as several nanometers. Thus, in the present invention there is an image sensor with pixels larger than the diffraction limit of visible light, and a positioning element which may move a specimen relative to the image sensor at distances less than the diffraction limit of light. Based upon the movement described, sub-pixels can be conceptualized and analyzed. These sub-pixels may each be less than the diffraction limit of light, but can be accorded their own value. Using modem image processing techniques, a basic statistic for all values in each sub-pixel can be generated, and a new image can be calculated, having greater resolution than the designed resolution of the image sensor. Thus, in relevant instances, the diffraction limit of visible light is no longer a barrier for potential measurement of nanoscale specimens.

### BRIEF DESCRIPTION OF THE DRAWINGS

FIG. 1 is a representational view of one embodiment of an apparatus in accordance with this invention, showing a fixed image sensor and a moveable specimen;

FIG. 2 is a representational view of one embodiment of an apparatus in accordance with this invention, showing a fixed specimen and a moveable image sensor;

FIG. 3A is a representation of an image sensor having 9 pixels, P1 through P9, and a specimen S focused thereon in pixel P5;

FIG. 3B is a representation of the display output from the image sensor of FIG. 3B;

FIG. 4 provides 16 representations of an image sensor and specimen focused thereon, as in FIG. 3A, with relative movement between the specimen and the image sensor showing 16 discrete positions for the specimen relative to the image sensor, and exemplary grey scale values are presented within given pixels P1 through P9 to show what the image sensor records for a given discrete position;

FIG. 5 is a representation of the display output of the image sensor for each discrete position of the specimen S as shown in FIG. 4;

FIG. 6 is a representation as in FIGS. 4 and 5, but with the pixels P1 though P9 of the image sensor being divided into sub-pixels in accordance with the relative movement between the specimen and the image sensor, and with a particular sub-pixel portion of the specimen S being marked with an “X” to appreciate how equivalent sub-pixels are established through the relative movement;

FIG. 7 is a general representation of the sub-pixels established for an image sensor in an exemplary practice of this invention;

FIG. 8A is a representation of the reconstruction of the image of specimen S in relation to the image sensor and its pixels and sub-pixels; and

FIG. 8B shows a reproduced sub-pixelated image resulting from the analysis of equivalent sub-pixels of FIGS. 4-6.

### DETAILED DESCRIPTION OF THE INVENTION

Techniques and apparatus are described, that compare multiple digital images of a specimen to increase the resolution of the image beyond the normal resolution of the digital image sensor. A specimen to be imaged is isolated in front of a digital image sensor, for example, a charged coupled device (CCD) or complementary metal oxide semiconductor (CMOS), and multiple images are captured. An image may be analyzed in the same manner using a monochrome or color image sensor.

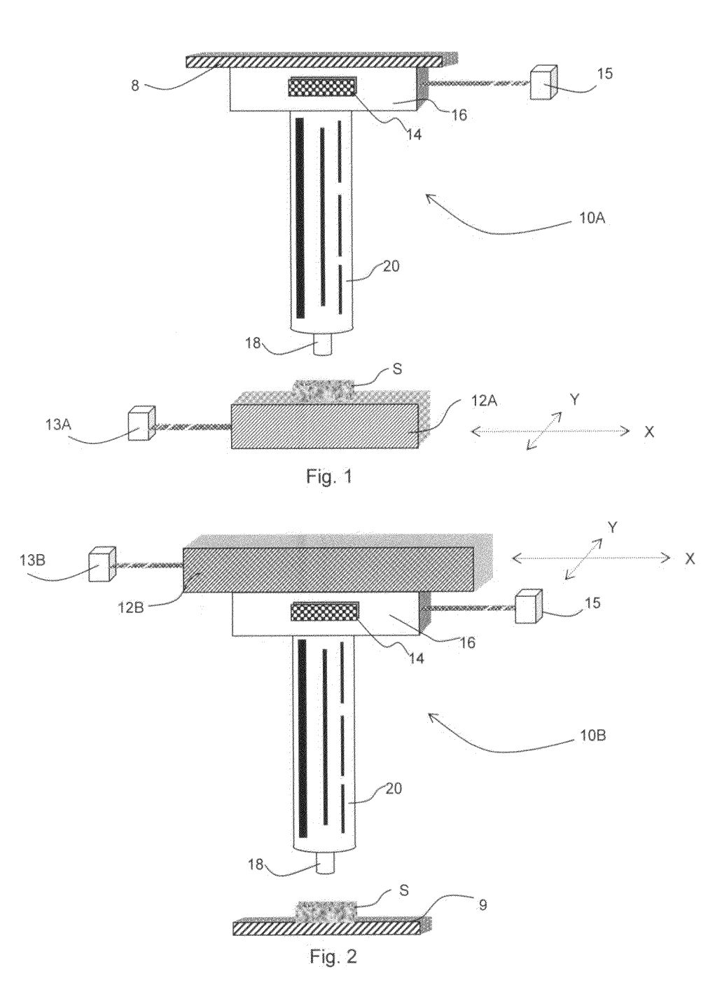

With reference to FIGS. 1 and 2, a general representation of an imaging apparatus that could be employed for the method herein is shown, by way of non-limiting examples, in two embodiments, one in FIG. 1 and the other in FIG. 2. The imaging apparatus of FIG. 1 is identified by the numeral 10A and the imaging apparatus of FIG. 2 is identified by the numeral 10B. The imaging apparatus 10A includes a nanopositioner 12A and a nanopositioner controller 13A serving to move a specimen S relative to an image sensor 14 that is to digitally record the image of the specimen S by means of sensor controller 15. The image sensor is typically, but not limited to, a CCD or CMOS sensor or the like. The image sensor 14 is retained in a housing 16, and the image of the specimen S is focused onto the image sensor 14 through a lens 18 and lens tube (objective) 20. The housing 16, image sensor 14, lens 18 and lens tube 20 make up the essential elements of a still electronic camera and are mounted in fixed position to non-moveable bracket 8. Not shown, but necessary to the capturing of the image is a light source. The application of light is well know to those familiar with microscopy and photography. Light for the invention may be transmitted through the specimen, or reflected incidentally from the specimen.

In imaging apparatus 10B, a nanopositioner 12B and nanopositoner controller 13B are associated with the housing 16, to move the image sensor 14 relative to the specimen S with the specimen S being fixed in position, for example, by being mounted to a non-moveable fixed stage 9. Thus, it is desired that a nanopositioner be employed to effect relative movement between the image sensor and the specimen, and it should be appreciated that the nanopositioner could be associated with the image sensor within a camera or otherwise associated with elements of an imaging apparatus to effect relative movement between a specimen and the image sensor.

The nanopositioner, as its name implies, may be programmed and controlled to move the specimen and/or image sensor in parallel planes relative to each other, as represented by the x-y coordinate arrows in FIGS. 1 and 2. The movement can be as small as nanometers (or smaller if the appropriate technology is available). As will be seen, the magnitude of relative movement is preferably less than the size of a pixel of the image sensor, and is chosen to create a desired pattern of sub-pixels.

In accordance with this invention, an image is digitally recorded at a first position, then the relative movement of the imaging sensor and specimen is carried, and a new image is taken at the new position. Preferably a multitude of images are taken at a multitude of positions. The relative movement is parallel to the plane of the image sensor (i.e., the specimen is not brought closer to or moved further away from the image sensor), and the distance of the movement is chosen to establish a pattern of sub-pixels in accordance with a desired increased resolution to be calculated and reproduced, as will become more apparent herein below.

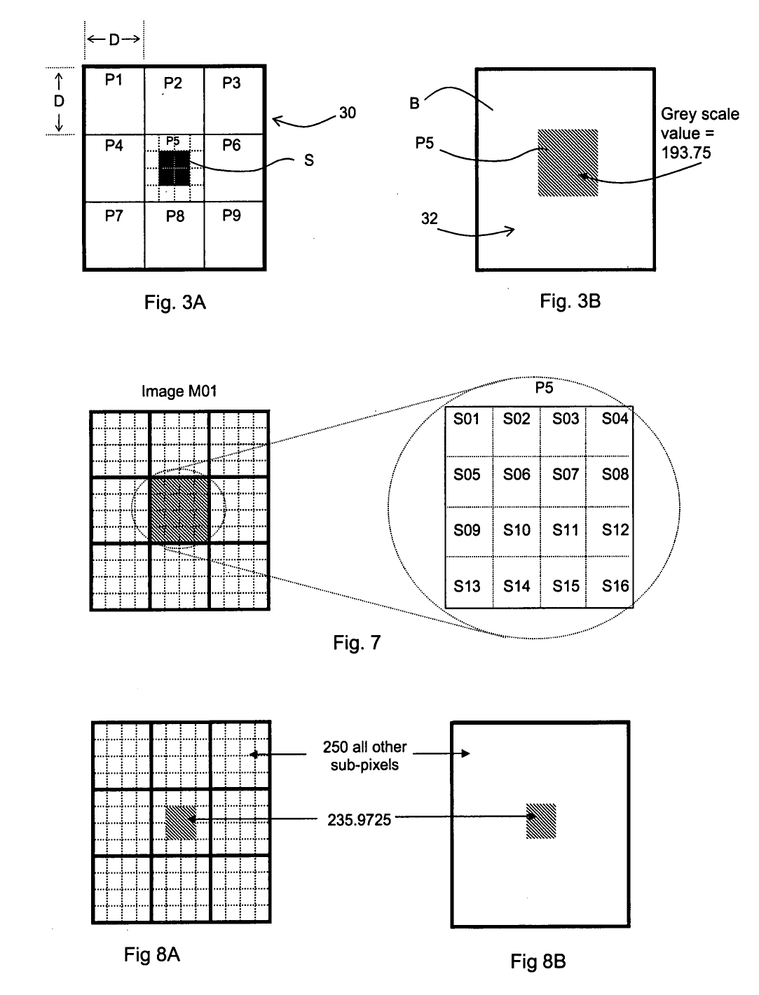

To illustrate the concept of this invention, a small example of an image sensor 30 with 9 pixels (labeled P1 through P9) is considered in FIG. 3A, and the image recorded thereby is considered in FIG. 3B, as the image sensor 30 records and displays an output of the image of a specimen S that is smaller than one pixel, i.e., the specimen S fits wholly within one pixel as it is focused thereon. In this example, the pixel is assumed to be square unless otherwise noted and the length and width of the pixel is shown by the letter D. FIG. 3A illustrates a specimen S as it is focused upon and recorded by a center pixel P5 of an image sensor 30. Dashed lines are included in FIG. 3A illustrate the relative size of the specimen S and the center pixel P5. FIG. 3B shows the display output 32 reflecting the discrepancy between the appearance of the specimen focused on the image sensor and the appearance of the specimen as output. For purposes of this description, it is assumed that a black and white image is being recorded in grey scale. The pixel PS will electronically record the light focused thereon, breaking it down to digital data, as known. The digital data will relate to a particular grey scale value for the entire pixel P5, as seen in FIG. 3B, wherein the grey scale value is output to the entire pixel P5. Notably, the image output as in FIG. 3B shows the specimen S as being the size of pixel P5, when, in fact, as seen in FIG. 3A, the specimen S is smaller than pixel PS.

For the purposes of this example, an 8 bit grey scale is used, such that a grey scale value of 0 is black and a grey scale value of 255 is white. Further for this example, the specimen is assigned a grey scale value of 25, while the background to the specimen is assigned a grey scale value of 250. In FIG. 3A, the specimen S fills 25% (4 of 16 subdivisions represented by dashed lines in FIG. 3A) of the pixel P5, and, thus, the digital data recorded for that pixel will reflect a pixel value, in grey scale, of 193.75. This is calculated from the understanding that the grey scale value for the pixel P5 will reflect the average of the grey scale value of the specimen S and background B focused onto that pixel P5. Conceptually, 4 subdivisions of pixel P5 receive a grey scale value of 25 from the specimen and 12 subdivisions of the pixel P5 receive a grey scale value of 250 from the background. The average equals 193.75, i.e., ((4×25)+(12×250))/16=193.75. Thus, with the specimen centered as shown in FIG. 3A, the pixel P5 records a grey scale value of 193.75 when the image is taken. This is the first image of multiple images to be taken. The displayed output from this image would be as seen in FIG. 3B. Here the entire pixel PS is a grey scale value of 193.75 and does not distinguish the actual specimen S from its background B. This invention provides a method by which the specimen S may be more accurately distinguished from its background.

In accordance with this invention, multiple images of the specimen are recorded at multiple discrete positions. To record multiple images, a nanopositioner is employed to effect relative movement between the image sensor and the specimen S, whether by being associated with the specimen, the image sensor or the camera. Broadly, the magnitude of movement is chosen based upon a desired sub-resolution to be calculated and reproduced, and preferably is also chosen based upon the size of the multiple pixels that make up the image sensor. The specimen is moved to a plurality of discrete positions relative to the image sensor to establish sub-pixels of a smaller size than the multiple pixels of the image sensor, and to further establish a plurality of equivalent sub-pixels, wherein equivalent sub-pixels are those sub-pixels that have the same portion of the specimen focused thereon at different discrete positions.

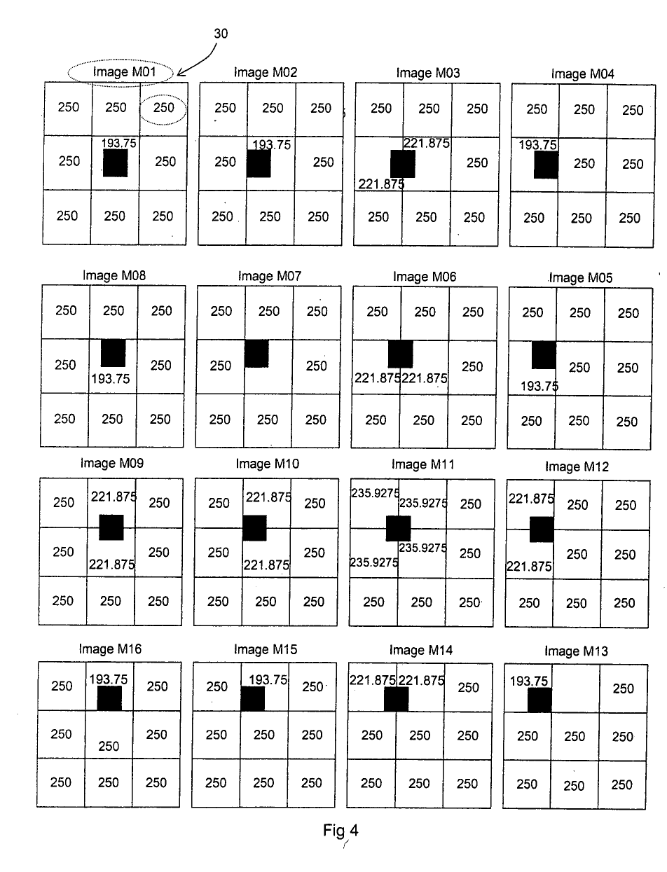

In the example based on the small image sensor 30 and specimen S of FIG. 3A, the nanopositioner is programmed to move stepwise in a number of discrete steps, i, in each of the x and y directions, wherein the magnitude of each step is D/i . An initial position is considered a step, i.e, the initial placement position is a “step,” and each movement thereafter is a “step.” In effect, this splits a single pixel into i² subpixels, each with a length and width of D/i. This can be appreciated in FIG. 4, where the specimen S is placed a four incremental x positions, and at each x position, is placed a four different y positions. In the example, i=4, hence 16 stepwise movements are made, and images are recorded at each discrete position. Preferably the specimen is moved in an “S” pattern to minimize specimen movement. For ease of reference, each image in FIG. 4 is provided with an image number abbreviated with the letter “M” before the number. Thus, FIG. 4 provides images M01 through M16.

At each of the four incremental y positions, four images are taken at four different incremental x positions. Images M02 to M04 are taken after incremental movements in the +x direction from image M01. Image M05 is taken after an incremental movement in the +y direction from image M04, and three more images, M06 to M08, are taken after incremental movements in the −x direction. Image M09 is taken after an incremental movement in the +y direction from image M08, and three more images, M10 to M12, are taken after incremental movement in the +x direction. Finally, for this example, image M13 is taken after an incremental movement in the +y direction from image M12, and three more images, images M14 to M16, are taken after incremental movements in the −x direction.

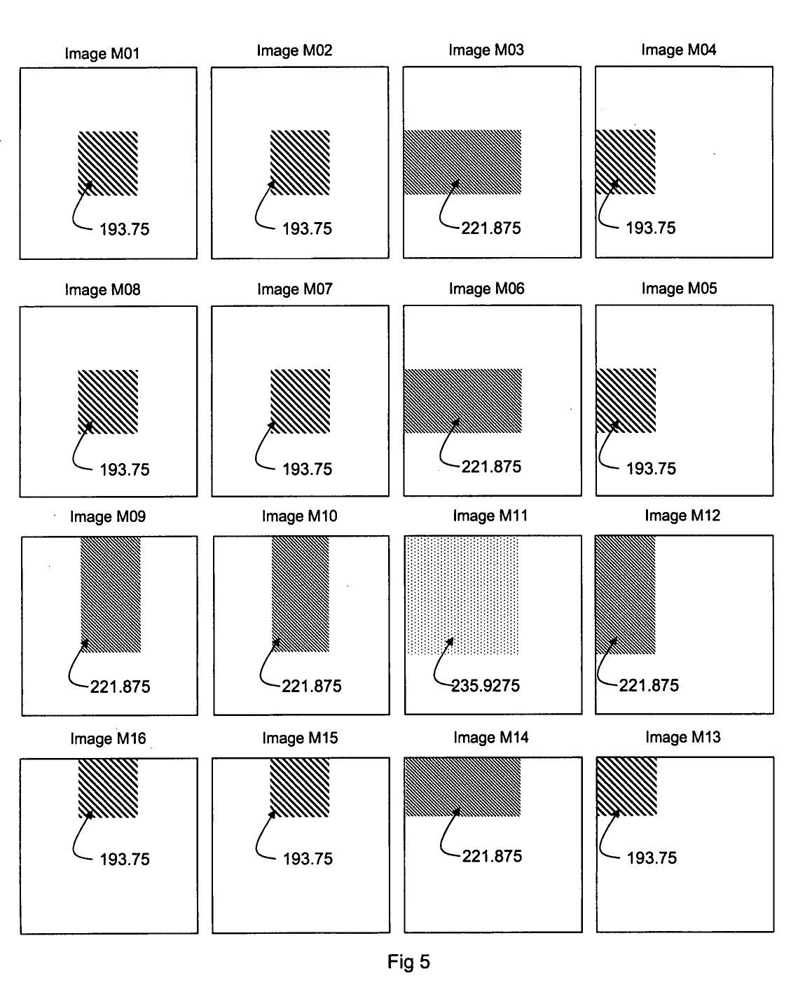

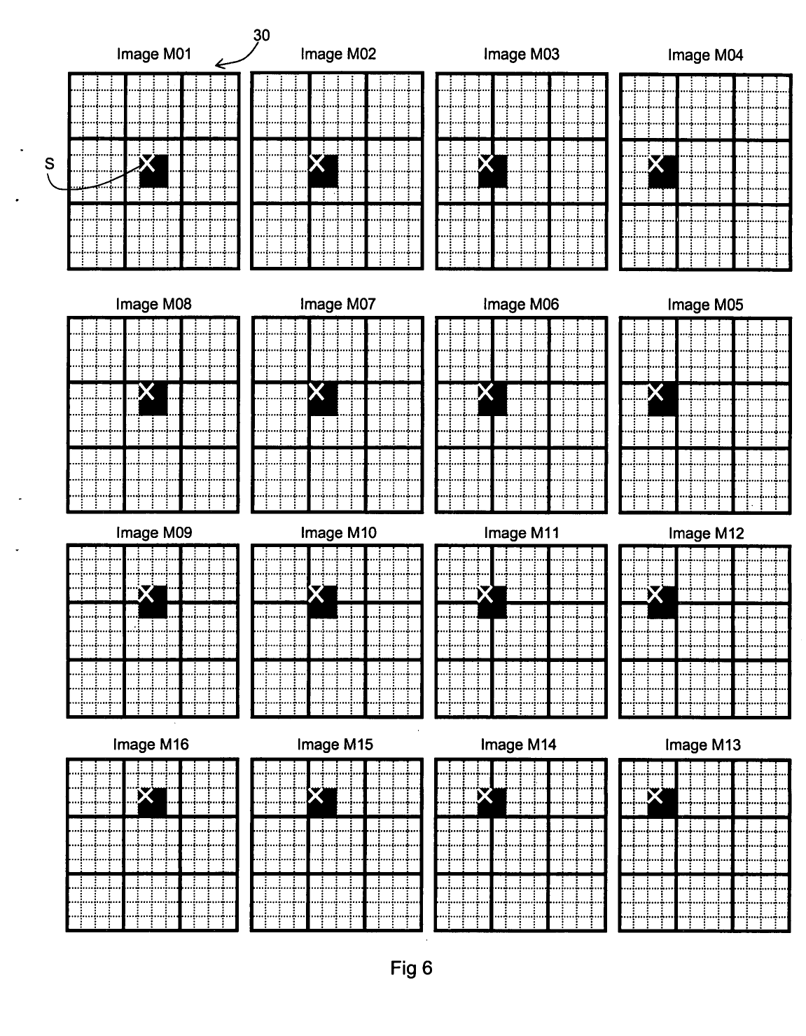

As already mentioned, it is preferred, although not required, that the number of discrete positions employed to create the map of images as shown in FIG. 4 (and FIGS. 5 and 6, discussed more below) be based upon the degree of incremental movement. In the present example, the increments were at ¼ of the pixel width (x direction) and height (y direction), thus establishing 16 different sub-pixels (4 divisions in width and 4 divisions in height) within each pixel P1 through P9, as can be best seen in FIG. 6, discussed more fully below. For a lesser sub-pixelation, the movement can be chosen to be ½ or ⅓ of the pixel width and height, which would result respectively in 4 sub-pixels (2 divisions in width and 2 in height) and 9 sub-pixels (3 divisions in width and 3 in height). Similarly, a greater sub-pixelation can be achieved by movement at ⅕ (25 sub-pixels, 5 divisions in width and 5 in height) or ⅙ (36 sub-pixels, 6 divisions in width and 6 in height) of the pixel width and height. Of course, even smaller movements could be employed.

The grey scale values for each pixel P1 through P9 are recorded for each discrete position of the specimen S relative to the image sensor 30. The data for each image is saved in an appropriate medium, and the means to store captured images is well known. Again, this involves an averaging of the specimen S and background B as focused onto the pixels of the image sensor. The grey scale pixel value for each image M01 though M16 is provided for each pixel of the image sensor 30, and is visually displayed in FIG. 5. A seen in a comparison of the grey scale values and images of FIGS. 4 and 5, the displayed image may be different depending on the relative location of the sensor to the specimen. The differences can provide useful information for resolving the image of the specimen, even though, in the exemplary embodiment, the specimen is smaller than a single pixel. To obtain such information, the sub-pixels established by the movement of the specimen are compared between the various images recorded. In this example, each pixel P1 through P9 of the image sensor 30 is divided into 16 sub-pixels (based on the 4 divisions in width and 4 divisions in height), as shown, with the number of sub-pixels being the same as the number of movements.

The sub-pixels are established based upon the movement of the specimen to a plurality of discrete positions for recording an image. Each sub-pixel can be mapped by an image number, pixel number and sub-pixel location. Each image M01 through M16 has its own 9 pixels, which can be mapped, with image M01 having pixels M01(P1), M01(P2), M01(P3) . . . to M01(P9) and image M02 having pixels M02(P1) through M02(P9), and so on for all images M01 through M16. Similarly, each conceptual sub-pixel can be mapped for a particular pixel, with pixel P1 having sub-pixels P1(S01), P1(S02), P1(S03), . . . to P1(S16) and pixel P2 having sub-pixels P2(S01) through P2(S16), and so on for all pixels P3 through P9. This is generally shown in FIG. 7, using image M01, pixel P5 as an example. Any given sub-pixel position can therefore be expressed by an image number, a pixel number and a sub-pixel number. For example, the “X” in image M01 of FIG. 6 can be expressed as being in sub-pixel position M01(P5)(S06). As known, each sub-pixel for a given image M01 through M16 is accorded the same grey scale value as the pixel in which it resides. For example, every sub-pixel of image M01, pixel P5 has a grey scale value of 193.75, just as every sub-pixel of image M11, pixel P5 (as well as pixels P1, P2 and P4) has a grey scale value of 235.9375.

With respect to the portion of the image that they record, certain sub-pixels will be appreciated to be equivalents of each other, in light of the known pattern of relative movement, i.e., a given area of the specimen is focused on different sub-pixels in different images, and these sub-pixels are therefore equivalent. To help illustrate this, an imaginary “X” is placed at a sub-pixel area of the specimen in FIG. 6, and moves with the specimen accordingly. With reference to FIG. 6 it will be appreciated that it is possible to map the correlation between sub-pixels and the portion of the image focused thereon as the specimen is moved. For example, with reference to the imaginary “X,” the following sub-pixels are equivalent sub-pixels: M01(P5)(S06), M02(P5)(S05), M03(P4)(S08), M04(P4)(S07), M05(P4)(S03), M06(P4)(S04), M07(P5)(S01), M08(P5)(S02), M09(P2)(S14), M10(P2)(S13), M11(P1)(S16), M12(P1)(S15), M13(P1)(S11), M14(P1)(S12), M15(P2)(S09), and M16(P2)(S10).

The grey scale values for the various pixels P1 through P9 in each image M01 through M16 have been provided in FIG. 4, and since every sub-pixel has the same grey scale value as the entire pixel in which it resides, the equivalent sub-pixels will receive different values at different positions, providing an array of sub-pixel and associated grey scale values, as follows in Table 1.

TABLE 1

| | Grey Scale Pixel |
|---|---|
| Sub-pixel | Value |
| M01(P5)(S06) | 193.75 |
| M02(P5)(S05) | 193.75 |
| M03(P4)(S08) | 221.875 |
| M04(P4)(S07) | 193.75 |
| M05(P4)(S03) | 193.75 |
| M06(P4)(S04) | 221.875 |
| M07(P5)(S01) | 193.75 |
| M08(P5)(S02) | 193.75 |
| M09(P2)(S14) | 221.875 |
| M10(P2)(S13) | 221.875 |
| M11(P1)(S16) | 235.9275 |
| M12(P1)(S15) | 221.875 |
| M13(P1)(S11) | 193.75 |
| M14(P1)(S12) | 221.875 |
| M15(P2)(S09) | 193.75 |
| M16(P2)(S10) | 193.75 |

These equivalent sub-pixels can be analyzed to reconstruct an image based upon the smaller size of the sub-pixels established by the relative movement between recording images. Different mathematical models can be applied to the analysis, but, in this example, the areas which reflect the most light are considered, and, therefore, the mathematical maximum value of all equivalent sub-pixels is employed in the reconstruction of a new image. In Table 1, the maximum grey scale value for the equivalent sub-pixels (relating to position “X”) is 235.9275. This maximum value can be used to reconstruct an image of the specimen S based upon the sub-pixels established. The sub-pixel values for the reconstructed image can be calculated through any applicable statistical function defined by the distribution of the pixel values attributed to all equivalent sub-pixels. Non-limiting examples of statistical functions include mean, median and mode, weighted averages, geometric mean and other Gaussian and non-Gaussian functions.

In FIG. 8A the image is reconstructed at its original position of image M01. Pixel P05, sub-pixel S06 in the reconstructed image is assigned the analyzed maximum value for the 16 equivalent sub-pixels from images M01 to M16, as obtained from consideration of the values in Table 1. This comparison of grey scale values is repeated for all equivalent sub-pixels, and new values are assigned in the reconstructed new image of FIG. 8A. Here, from a review of FIGS. 4-6, it will be appreciated that 4 sub-pixels, S05, S06, S09, S10, have maximum values of 235.9275. All other sub-pixels have maximum values of 250.

FIG. 8B shows the new image as calculated and reproduced (through know image production technology, either in print form or electronically displayed or otherwise). Although the image of the specimen is a lighter shade of grey than that of the actual specimen S, it does show the contrast which distinguishes the specimen from its background by showing the specimen in resolution greater than the image sensor that was used to record the various images at discrete positions. Without application of this invention, the specimen could not be distinguished as evident by FIG. 5, images M01 to M16, and, particularly, FIG. 3B.

A key advantage is that the pixel size can be greater than the wavelength of light, whereas the movement can be much smaller than the wavelength of light. The result is that an specimen smaller than the wavelength of light can be imaged.

In accordance with the example above relating to FIGS. 3-8, the specimen is moved stepwise in an x direction and stepwise in a y direction at distances less than the x and y dimensions of the pixels of an image sensor. This serves to conceptually split the pixels of the image sensor into sub-pixels. The number of steps in each direction is chosen based on the desired number of sub-pixels to be established for each pixel of the image sensor. Here, the number of steps in each direction is 4, establishing a new 4 by 4 grid of sub-pixels within the pixels of the image sensor. More broadly, by designating the number of steps in a given direction as i, and understanding that the original position of the specimen is counted as a step, the distance of a step in the x direction is to be defined by D/i, and the distance of a step in the y direction is also defined by D/i. Hence the total number of steps is i². Notably, i² is also the number of sub-pixels created in each pixel of the image sensor. If one wishes to divide the pixels of the image sensor into 4 equal sub-pixels (i.e., a 2 by 2 grid), then i is chosen to be 2, and the distance of a step is D/2, and the number of steps and images taken is 4. These general equations can be followed to establish 4, 9, 16, 25, 36 etc. sub-pixels for the pixels of an image sensor. The maximum number images that can be recorded will only being limited by computer storage and processing speeds.

It will be appreciated that the degree of resolution of the reproduced image will depend upon the sub-pixels established by moving the specimen relative to the image sensor. Preferred stepwise movements have been described for establishing sub-pixels, but it will be appreciated that sub-pixels could be established in a multitude of ways, including irregular relative movement to non-adjacent sub-pixels, as opposed to the regular relative movement to adjacent sub-pixels as shown in the example herein. Although it is preferred that the sub-pixels split the pixels of the image sensor into a symmetrical grid, as in the example shown, it will be appreciated that sub-pixels could be established that are split by the boundaries of the pixels of the image sensor, though the ability to analyze equivalent sub-pixels so divided and to attribute calculated values to those divided sub-pixels will be difficult. Particularly, a portion of a divided sub-pixel might be associated with a pixel of a particular value, while another portion or portions of that divided sub-pixel might be associated with different pixels of different values.

Preferred embodiments have also shown the sub-pixels to be square, but it will be appreciated that the concepts of this invention can be practiced with relative movements establishing sub-pixels of irregular shape.

Sub-pixels for the entire image sensor could be established simply by recording a first image of the specimen at an initial discrete position and then moving to a second discrete position and recording an image, so long as the sub-pixels are chosen to create a grid pattern that creates equivalent sub-pixels. The image may even be moved in only one direction if non-square sub-pixels are desired. A minimum of two discrete positions can be used to establish square sub-pixels if the specimen is moved in both the x and y directions from the first discrete position to the second discrete position. Regardless of where the specimen is moved relative to the image sensor, a sub-pixel grid could be established to provide equivalent sub-pixels.

While various movements can establish desired sub-pixels, some movement patterns will likely be found to be better at providing an improved resolution, whether by providing better results or by decreasing the complexity of calculation necessary to reproduce an image based on the sub-pixels. Stepwise patterns that focus on moving along adjacent sub-pixels, such as in the S-shape movement shown in FIGS. 4-6, are preferred over patterns that jump around to non-adjacent sub-pixels, because the stepwise patterns will likely provide better resolution along a contrast boarder of the image, meaning those areas of contrast running through a pixel on an imaging sensor. In the example of FIGS. 3-8, the contrast boarder is between the boarders of the square specimen S and its background B. Notable the pixels cannot record this contrast boarder because a single value must be attributed an entire pixel. As long as a specimen is moved such that equivalent sub-pixels can be analyzed, an analysis of equivalent sub-pixels can be performed, and new values can be calculated to reproduce an image based on all sub-pixels; however, movement along adjacent sub-pixels is preferred for the focus on contrast boarders. Although an S-shape is the movement currently being practiced, others could be found to be more suitable to achieving a desired result.

In light of the foregoing, it should be appreciated that the present invention advances the art of imaging techniques and imaging apparatus. Although a particular exemplary embodiment has been employed for the purpose of disclosure herein, the invention is not limited thereto or thereby, and the scope of this invention shall, in accordance with the patent laws, be defined by the following claims.

1. A method for using an image sensor to obtain an image of a specimen focused thereon, such that the resolution of the image obtained is greater than the designed resolution of the image sensor, the method comprising the steps of:
focusing a specimen onto an image sensor having multiple pixels;
relatively moving the specimen and image sensor in planes parallel to one another such that the relative movement is in either x or y directions or both, and the relative movement is such that the specimen is placed at a plurality of discrete positions relative to the image sensor to establish sub-pixels and a plurality of equivalent sub-pixels, wherein equivalent sub-pixels are those sub-pixels that have the same portion of the specimen focused thereon at different discrete positions;
digitally capturing an image of the specimen by means of the image sensor at each of the plurality of discrete positions, wherein a pixel value is recorded for each of the multiple pixels of the image sensor, with the understanding that the pixel value recorded for a given pixel is attributed to all sub-pixels established in that pixel;
determining a sub-pixel value for each sub-pixel of the image sensor based upon the values attributed to equivalent sub-pixels in said step of digitally capturing; and
reproducing a sub-pixelated image of the specimen based on the sub-pixel values calculated in said step of determining.

2. The method of claim 1, wherein, in said step of relatively moving, the sub-pixels established are of a uniform size.

3. The method of claim 2, wherein the relative movement from a first discrete position to an immediately following second discrete position of said plurality of discrete positions is in either the x or y direction or both and any movement in the x direction is at a distance greater than the dimension of the sub-pixels in the x direction and any movement in the y direction is at a distance greater than the dimension of the sub-pixels in the y direction such that the equivalent sub-pixels established between such first and second discrete positions are non adjacent.

4. The method of claim 2, wherein the relative movement from a first discrete position to an immediately following second discrete position of said plurality of discrete positions is in either the x or y direction and movement in the x direction is at a distance equal to the dimension of the sub-pixels in the x direction and movement in the y direction is at a distance equal to the dimension of the sub-pixels in the y direction such that the equivalent sub-pixels established between such first and second discrete positions are offset by a sub-pixel length or width.

5. The method of claim 1, wherein the multiple pixels of the image sensor are square, having a length and width D, and the relative movement is stepwise in the x direction and stepwise in the y direction, with the distance of the stepwise relative movement being equal to D/i, wherein i equals an integer and is selected based upon the desired size of a sub-pixel, which, in accordance with the relative movement so described.

6. The method of claim 5, wherein the stepwise relative movement is in an S-shape, and i² discrete positions are established in said step of relatively moving, and i² images are digitally captured in said step of digitally capturing.

7. The method of claim 1, wherein, in said step of determining a sub-pixel value, the value of a sub-pixel is determined to be the maximum of the pixel values attributed to all equivalent sub-pixels.

8. The method of claim 1, wherein, in said step of determining a sub-pixel value, the value of a sub-pixel is determined to be the minimum of the pixel values attributed to all equivalent sub-pixels.

9. The method of claim 1, wherein, in said step of determining a sub-pixel value, the value of a sub-pixel is determined to be the mean of the pixel values attributed to all equivalent sub-pixels.

10. The method of claim 1, wherein, in said step of determining a sub-pixel value, the value of a sub-pixel is determined to be the median of the pixel values attributed to all equivalent sub-pixels.

11. The method of claim 1, wherein, in said step of determining a sub-pixel value, the value of a sub-pixel is determined to be the mode of the pixel values attributed to all equivalent sub-pixels.

12. The method of claim 1, wherein the equivalent sub-pixels are analyzed by an applicable statistical function defined by the distribution of the pixel values attributed to all equivalent sub-pixels.
